(19) United States
(12) Patent Application Publication
(10) Pub. No.: US 2024/0221077 A1
(43) Pub. Date: Jul. 4, 2024

(54) SECURITIES-BASED OFFER VERIFICATION AND PRESENTATION

(71) Applicant: TIICKER, INC., Detroit, MI (US)

(72) Inventors: Jeffrey Todd Lambert, Grand Rapids, MI (US); Christopher John Tromp, Byron Center, MI (US); Michael John Houston, Vineyard, UT (US)

(21) Appl. No.: 18/375,711

(22) Filed: Oct. 2, 2023

Related U.S. Application Data
(63) Continuation of application No. 17/119,515, filed on Dec. 11, 2020, now abandoned.
(60) Provisional application No. 62/946,731, filed on Dec. 11, 2019.

(51) Int. Cl. G06Q 40/04

(52) U.S. Cl. CPC G06Q 40/04

(57) ABSTRACT

Methods and systems for verifying securities-based offers are provided. In one embodiment, a method is provided that includes receiving security transaction data reflecting transactions of a plurality of securities within a securities account. A particular security may be identified that corresponds to an offer. A holding period of one or more shares of the particular security may be determined. The offer may be verified based on the holding period and may be transmitted to a first computing device associated with the securities account.

### PRIORITY CLAIM

The present application is a continuation of U.S. application Ser. No. 17/119,515 filed Dec. 11, 2020, which claims priority to and the benefit of U.S. Provisional Application 62/946,731 filed Dec. 11, 2019, each of which is herein incorporated by reference.

### BACKGROUND

Companies may present offers to customers or other related individuals. The offers may allow for discounts on products sold or otherwise related to the company. For example, companies may circulate coupons or discount codes that can be used by customers to provide discounts on certain products sold by the company.

### SUMMARY

The present disclosure presents new and innovative systems and methods for verifying securities-based offers. In a first aspect, a method is provided that includes receiving security transaction data reflecting transactions of a plurality of securities within a securities account and identifying a particular security of the plurality of securities that corresponds to an offer. The method may further include determining a holding period of one or more shares of the particular security. The method may also include verifying the offer based on the holding period and transmitting the offer to a first computing device associated with the securities account.

In a second aspect according to the first aspect, the security transaction data includes information on the dates of a plurality of transactions involving the plurality of securities and quantities of the plurality of securities that purchased or sold in the plurality of transactions.

In a third aspect according to any of the first and second aspects, verifying the offer comprises determining that the holding period exceeds a minimum holding period specified by the offer.

In a fourth aspect according to the third aspect, verifying the offer comprises determining that a minimum quantity of shares have a holding period greater than the minimum holding period.

In a fifth aspect according to the fourth aspect, determining the holding period includes analyzing transactions of the particular security from the security transaction data. The transactions may be analyzed in reverse chronological order to ensure that the minimum quantity of shares was held for all of the minimum holding period.

In a sixth aspect according to any of the first through fifth aspects, the method further includes receiving, from the first computing device, a request to redeem the offer and redeeming the offer on behalf of the first computing device.

In a seventh aspect according to the sixth aspect, redeeming the offer includes at least one of (i) providing a discount code for use at a third-party shopping platform, (ii) providing access to a company store provided by a company associated with the particular security, (iii) processing a transaction with the company associated with the particular security on behalf of the first computing device.

In an eighth aspect according to any of the first through seventh aspects, the offer includes access to content regarding a company associated with the particular security, the content including one or more of written content, audio content, and video content.

In a ninth aspect according to any of the first through eighth aspects, transmitting the offer includes displaying the offer in a graphical user interface on the first computing device.

In a tenth aspect according to the ninth aspect, the graphical user interface includes ads that, when selected, redirect to content accessible without leaving the graphical user interface.

In an eleventh aspect, a system is provided that includes a processor and a memory. The memory may store instructions which, when executed by the processor, cause the processor to receive security transaction data reflecting transactions of a plurality of securities within a securities account and identify a particular security of the plurality of securities that corresponds to an offer. The instructions may also cause the processor to determine a holding period of one or more shares of the particular security. The instructions may further cause the processor to verify the offer based on the holding period and transmit the offer to a first computing device associated with the securities account.

In a twelfth aspect according to the eleventh aspect, the security transaction data includes information on the dates of a plurality of transactions involving the plurality of securities and quantities of the plurality of securities that purchased or sold in the plurality of transactions.

In a thirteenth aspect according to any of the eleventh and twelfth aspects, verifying the offer comprises determining that the holding period exceeds a minimum holding period specified by the offer.

In a fourteenth aspect according to the thirteenth aspect, verifying the offer comprises determining that a minimum quantity of shares have a holding period greater than the minimum holding period.

In a fifteenth aspect according to the fourteenth aspect, determining the holding period includes analyzing transactions of the particular security from the security transaction data. The transactions may be analyzed in reverse chronological order to ensure that the minimum quantity of shares was held for all of the minimum holding period.

In a sixteenth aspect according to any of the eleventh through fifteenth aspects, the instructions further cause the processor to receiving, from the first computing device, a request to redeem the offer and redeeming the offer on behalf of the first computing device.

In a seventeenth aspect according to the sixteenth aspect, redeeming the offer includes at least one of (i) providing a discount code for use at a third-party shopping platform, (ii) providing access to a company store provided by a company associated with the particular security, (iii) processing a transaction with the company associated with the particular security on behalf of the first computing device.

In an eighteenth aspect according to any of the eleventh through seventeenth aspects, the offer includes access to content regarding a company associated with the particular security, the content including one or more of written content, audio content, and video content.

In a nineteenth aspect according to any of the eleventh through eighteenth aspects, transmitting the offer includes displaying the offer in a graphical user interface on the first computing device.

In a twentieth aspect, a non-transitory, computer-readable medium is provided that stores instructions which, when executed by the processor, cause the processor to receive security transaction data reflecting transactions of a plurality of securities within a securities account. The instructions may further cause the processor to identify a particular security of the plurality of securities that corresponds to an offer and determine a holding period of one or more shares of the particular security. The instructions may also cause the processor to verify the offer based on the holding period and transmit the offer to a first computing device associated with the securities account.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 illustrates a system for verifying and providing securities-based offers according to an exemplary embodiment of the present disclosure.

FIG. 2 illustrates a system for accessing and verifying security transaction information according to an exemplary embodiment of the present disclosure.

FIG. 3 illustrates an offer verification scenario according to an exemplary embodiment of the present disclosure.

FIG. 4 illustrates a method for verifying and providing securities-based offers according to an exemplary embodiment of the present disclosure.

FIGS. 5A-5D illustrate graphical user interfaces according to exemplary embodiments of the present disclosure.

FIG. 6 illustrates a computing system according to an exemplary embodiment of the present disclosure.

### DETAILED DESCRIPTION OF EXAMPLE EMBODIMENTS

Existing systems for presenting offers to consumers have limited targeting capabilities. For example, systems exist to make discount codes available to all users and/or to specific customers (e.g., customers with loyalty accounts with a particular retailer). As another example, customers may unlock or otherwise access discounts based on a total purchase amount or when purchasing specific types of goods. These systems can help improve customer loyalty, but have limited ability to encourage customers to truly engage with the success of the company and its products, including financial exposure to benefit from when the company succeeds.

One solution to this problem is to provide unique offers to users that are financially invested in a company. However, properly verifying individuals' qualifications for a particular offer is necessary to ensure that the offers are only presented to the correct individuals. Therefore, there exists a need to analyze and verify securities portfolio holdings for individuals and to match the holdings of an individual to one or more offers that the individual qualifies for based on their security holdings. In particular, such offers may be related to one or more companies associated with securities (e.g., stocks) held in the individual's portfolio. These offers may include various requirements, such as a minimum number of shares that the individual must hold and/or a minimum holding period for which the individual must hold the shares. To verify that an individual complies with these requirements, the computing system may analyze transaction information from the individual's portfolio. In particular, current holdings information may be analyzed to determine whether a user currently holds any securities with associated offers. If so, transaction data may be analyzed in a reverse chronological order to ensure that the individual has continued to hold the securities for at least the minimum holding period. If the individual has held the shares for the minimum holding period, the individual may be presented with the offer for redemption.

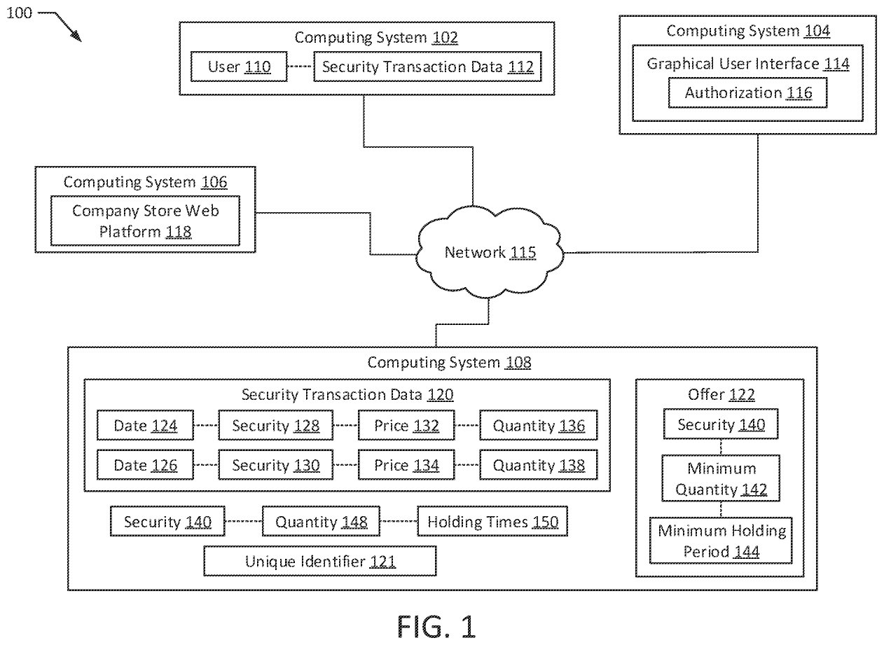

FIG. 1 illustrates a system 100 for verifying and providing securities-based offers according to an exemplary embodiment of the present disclosure. In particular, the system 100 may be configured to access information about securities held by an individual and to identify corresponding securities-based offers that the user qualifies for based on their securities holdings. The system 100 includes computing systems 102, 104, 106, 108 and a network 614.

The computing system 108 may be configured to communicate with one or more of the other computing systems 102, 104, 106 to verify whether a particular user qualifies for a securities-based offer. In particular, the computing system 108 may be configured to receive security transaction data 120 and may use the security transaction data 120 to verify whether the user qualifies for one or more securities-based offers 122. Securities-based offers 122 (also referred to as offers within the present disclosure) may be restricted to users holding particular securities for a predetermined period of time. These securities may include stocks, bonds, mutual funds, exchange-traded funds, or any other financial instruments. In one implementation, the securities include shares of stocks in the company providing the offer 122. In particular, securities-based offers 122 may offer one or more incentives, such as discounts, exclusive products, free products, access to restricted online storefronts (e.g., company stores), and access to recommend contents regarding a company (e.g., news content, or other text-based content, audio content, and video content). In one specific example, the offer 122 may include a discount (e.g., 10% off) on products sold by a company associated with a particular security, and the discount may be accessed (e.g., using a discount code) on one or more retail platforms (e.g., online stores, retail stores), which may or may not be associated with the company. In another specific example, the offer 122 may include access to a company store web platform 118 offered by the company associated with the security 140. The company store web platform 118 may be provided by a computing system 106 associated with the company. The company store web platform 118 may include discounted products sold by the company and/or exclusive products not sold by the company anywhere else. Securities-based offers 122 may specify the requirements a user must meet to access the corresponding incentive. For example, the offers 122 may specify a security 140 that the user must hold, along with one or more of a minimum quantity 142 and a minimum holding period 144 for the security 140. For example, the minimum quantity 142 may specify a particular quantity of shares of the security 140 that the user must hold in order to access the incentive specified by the offer 122. The minimum holding period 144 may specify a minimum period of time for which the user must hold any required shares to access the incentive. As a specific example, the offer 122 may require that a user hold 20 shares of a particular security 140 for at least three months. In such instances, the minimum quantity 142 may be 20 and the minimum holding period 144 may be three months.

To verify whether a user qualifies for an offer 122, the computing system 108 may receive and analyze security transaction data 120. The security transaction data 120 may reflect security transactions made by the user. For example, a user associated with the computing system 104 may access a platform (e.g., a web platform) provided by the computing system 108 or another related computing system via a graphical user interface 114. The user may provide authorization 116 to the computing system 108 needed to receive security transaction data 120 for the user. Based on the security transaction data 120, the computing system 108 may identify one or more corresponding offers 122 for which the user qualifies. The computing system 108 may receive the security transaction data 120 from another computing system 102 separate from the computing system 104 associated with the user. For example, the computing system 102 may be associated with a financial API (e.g., the Stripe® API) and/or with a financial services provider (e.g., a securities broker, an online trading platform, a bank). The computing system 102 may store or otherwise access security transaction data 112 associated with multiple users 110. The computing system 108 may request security transaction data 120. For example, the authorization 116 may be provided to the computing system 102 (e.g., directly via the computing system 104 and/or indirectly via the computing system 108). Based on the authorization 116, the computing system 102 may issue a unique identifier 121, such as a token or API key, to the computing system 108. The computing system 108 may then provide the unique identifier 121 to the computing system 102 along with a request for associated security transaction data. Based on the unique identifier 121, the computing system 102 may identify a corresponding user. The computing system 102 may then transmit the security transaction data 120 associated with the corresponding user to the computing system 108.

The security transaction data 120 may include information about individual security transactions made by or on behalf of the user. For example, the security transaction data 120 may include dates 124, 126 of transactions, securities 128, 130 bought or sold by the transaction, prices 132, 134 paid or received for the securities 128, 130, and quantities 136, 138 of securities 128, 130 that were bought or sold during the transaction. In certain instances, as discussed further below, the computing system 108 may separately receive holdings data reflecting current holdings by the user. Based on the security transaction data 120 and/or the current holdings data, the computing system 108 may identify one or more securities currently held by the user that have associated offers 122. For example, although not depicted, the computing system 108 may be communicatively coupled to a database storing multiple offers 122 with corresponding securities. The computing system 108 may compare one or more of the securities held by the user to offers stored in the database and may identify one or more offers that correspond to securities held by the user. For example, the computing system 108 may determine that the user currently holds one or more shares of the security 140 associated with the offer 122.

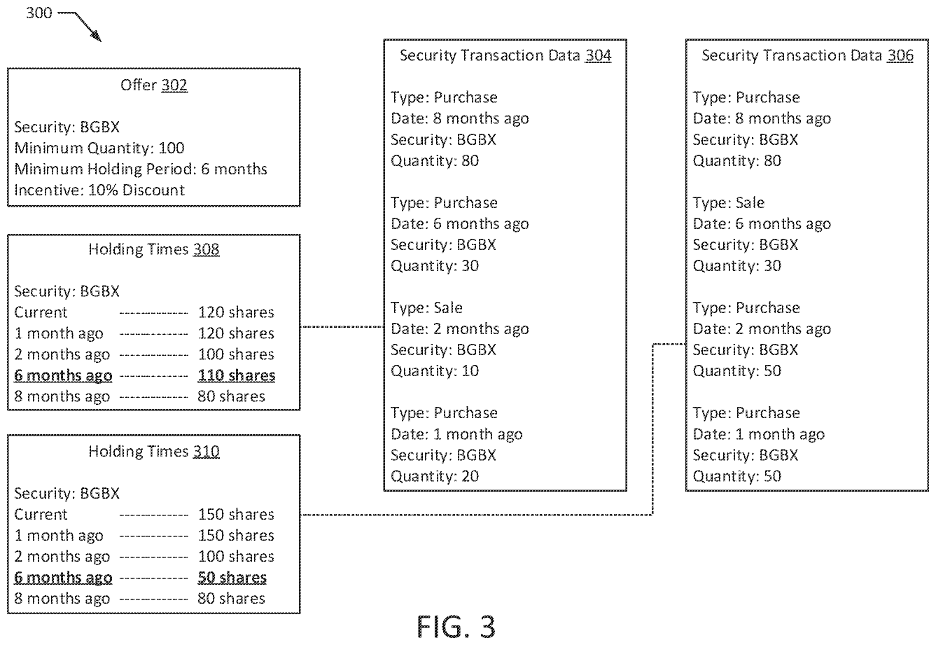

The computing system 108 may then determine holding times 150 for a quantity 148 shares of the security 140. For example, the computing system 108 may determine holding times 150 for a quantity 148 shares equivalent to the minimum quantity 142 identified by the offer 122. Continuing the previous example, the computing system 108 may determine holding times 150 for 20 shares of the security 140. Based on whether the holding times 150 exceed the minimum holding period 144, the computing system 108 may determine whether the user qualifies for the offer 122. For example, the computing system 108 may determine whether holding times 150 are at least greater than or equal to the minimum holding period 144. If so, the computing system 108 may determine that the user qualifies for the offer 122. If not, the computing system 108 may determine that the user does not qualify for the offer 122. One such example calculation is explained in greater detail below in connection with FIG. 3.

The computing systems 102, 104, 106, 108 may communicate via the network 614. For example, the computing systems 102, 104, 106, 108 may communicate using one or more application programming interfaces (APIs). The computing systems 102, 104, 106 may communicate with the network 115 using one or more wired network interfaces (e.g., Ethernet interfaces) and/or wireless network interfaces (e.g., Wi-Fi®, Bluetooth®, and/or cellular data interfaces). In certain instances, the network 115 may be implemented as a local network (e.g., a local area network), a virtual private network, L1 and/or a global network (e.g., the Internet). Furthermore, although not depicted, one or more of the computing systems 102, 104, 106 may contain a processor and a memory that implements at least one operational feature. For example, the memory may contain instructions which, when executed by the processor, cause the processor to implement at least one operational feature of the computing system 102, 104, 106, 108.

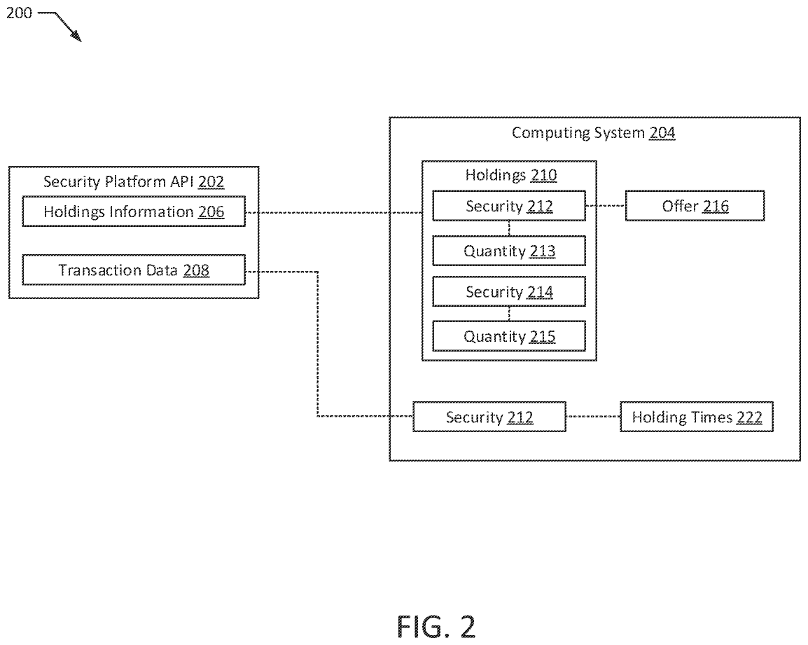

FIG. 2 illustrates a system 200 for accessing and verifying security transaction information according to an exemplary embodiment of the present disclosure. The system 200 includes a security platform API 202 and a computing system 204. The system 200 may be an exemplary implementation of communications between the computing system 102 and the computing system 108. For example, the computing system 204 may be an exemplary implementation of the computing system 108 and the security platform API 202 and be an exemplary implementation of an API used communicate with the computing system 102. In one specific example, the security platform API 202 may be implemented or otherwise provided by a Stripe® API.

The security platform API 202 may provide holdings information 206 and transaction data 208. The holdings information 206 may specify the current holdings 210 of a user. For example, the holdings 210 may identify securities 212, 214 held by the user and quantities 213, 215 of shares of the securities 212, 214 held by the user. Based on the holdings 210, the computing system 204 may initially identify and offer 216 that the user may qualify for. For example, the offer to 16 may correspond to the security 212 held by the user. In certain implementations, the computing system 204 may further ensure that the quantity 213 of shares of the security 212 held by the user exceeds a minimum quantity specified by the offer 216.

The computing system 204 may then verify holding times 222 for the minimum quantity of shares of the security 212 based on the transaction data 208. In particular, the transaction data 208 may store information similar to the security transaction data 212. Based on the transaction data 208, the computing system 204 may determine whether holding times 222 for the minimum quantity of shares of the security 212 exceeds a minimum quantity specified by the offer 216. This calculation is detailed further below in connection with FIG. 3.

Information, including the holdings information 206 and the transaction information 208 may be exchanged between the security platform API 202 and the computing system 204 together and/or separately. For example, the computing system 204 may make two separate API calls to the security platform API 202. In response to a first API call, the security platform 202 may transmit the holdings information 206 to the computing system 204. In response to a second API call, the security platform API 202 may transmit the transaction data 208 to the computing system 204. In additional or alternative implementations, the computing system 204 may transmit a single API call requesting both holdings information and transaction data. In response, the security platform API 202 may transmit both the holdings information 206 and the transaction data 208.

It should be understood that the data structures and information transmitted between the security platform API 202 and the computing system 204 in FIG. 2 are merely exemplary. For example, in additional or alternative implementations, the security platform API 202 may transmit additional or alternative information to the computing system 204. In one particular example, the holdings information 206 may include additional information beyond the securities 212, 214 and the quantities 213, 215.

FIG. 3 illustrates an offer verification scenario 300 according to an exemplary embodiment of the present disclosure. The offer verification scenario 300 may represent analysis performed by a computing system 108, 204 to determine whether a user qualifies for an offer 302. In addition to the offer 302, the scenario 300 includes security transaction data 304, 306 and holding times 308, 310. The offer 302 specifies that, in order to receive a particular incentive (i.e., a 10% discount on products sold), a user is required to hold a minimum quantity of 100 shares of BigBox Stores (ticker symbol BGBX) for a minimum period of six months. These conditions may thus require a user to maintain a minimum holding of 100 shares for the six months preceding the current date (e.g., the date at which the customer is to receive the incentive).

The scenario 300 compares the security purchases of two different users. A first user is associated with the security transactions data 304 and the holding times 308 and a second user is associated with the security transaction data 306 and the holding times 310. The security transaction data 304, 306 includes information on security transactions performed by the first and second users. In particular, the security transaction data 304, 306 specifies a type of transaction (e.g., a security sale, a security purchase), a date of the transaction (represented in the figure as relative dates of ““X months ago”), a security bought or sold during the transaction, and a quantity of shares bought or sold. It should be understood that the information contained within the security transaction data 304, 306 is merely exemplary and may vary according to the understanding of one skilled in the art in light of the present disclosure. For example, rather than representing the dates as relative dates, the security transaction data 304, 306 may include specific dates (e.g., month, day, year), and the computing system 108, 204 may determine the relative dates. Furthermore, in practice, the security transaction data 304, 306 may include transactions for securities other than BGBX. However, such transactions were omitted from FIG. 3 for clarity.

The holdings 308, 310 may be determined based on the security transaction data 304. For example, the computing system 108, 204 may process the transactions in reverse chronological order to determine whether the specified minimum quantity of shares were held for the entire minimum holding period. In particular, the computing system 108, 204 may use holdings information 206 to determine a current quantity of shares of the BGBX security that are held by the users. As shown in their respective holding times 308, 310, the first user currently has 120 shares of BGBX and the second user has 150 shares of BGBX. Accordingly, both users currently hold more than the minimum quantity of BGBX specified in the offer 302.

The computing system 108, 204 may then step through each of the BGBX transactions in reverse chronological order for at least the minimum holding period to ensure that the minimum quantity of BGBX was held for the entire minimum holding period. Focusing on the security transaction data 304 and the holding times 308 for the first user, the first user currently holds 120 shares, which remains consistent until the most recent transaction one month ago, when the first user purchased 20 shares of BGBX. To determine the shares held before this transaction (e.g., after the next most recent transaction two months ago), the 20 shares purchased are subtracted from the total holdings, for a holding two months ago of 100 shares of BGBX, as reflected in holding times 308. At the transaction two months ago, the first user sold 10 shares of BGBX. Therefore, to determine the first user's holdings before that transaction (e.g., at the time of the next most recent transaction six months ago), 10 shares are added to the first user's total holdings two months ago. Accordingly, the holding times 308 indicate holdings of 110 shares six months ago. As emphasized in the holding times 308, the first user held 110 shares of BGBX six months ago and maintained 100 or more shares for the entire minimum holding period of six months. Accordingly, the computing system 108, 204 may determine that the first user qualifies for the offer 302.

Turning to the second user and the corresponding security transaction data 306 and holding times 310, the second user currently holds 150 shares, which remains consistent until the most recent transaction one month ago, when the second user purchased 50 shares of BGBX. To determine the shares held before this transaction (e.g., after the next most recent transaction two months ago), the 50 shares purchased are subtracted from the current total holdings, for holding two months ago of 100 shares, as reflected in holding times 310. At the transaction two months ago, the second user purchased 50 shares of BGBX. Therefore, to determine the second user's holdings before that transaction (e.g., at the time of the next most recent transaction six months ago), 50 shares are subtracted from the second users total holdings of BGBX two months ago. Accordingly, the holding times 310 indicate holdings of 50 shares of BGBX six months ago, as reflected in the holding times 310. As emphasized in the holding times 310, the second user held 50 shares of BGBX six months ago. Therefore, although the second user currently holds more than the minimum quantity of 100 shares of BGBX (and more shares of BGBX than the first user), the computing system 108, 204 may determine that the second user does not qualify for the offer 302.

In light of the present disclosure, additional or alternative calculation techniques may occur to one skilled in the art. Furthermore, the timestamps used for the holding times 308, 310 merely illustrative. Additional or alternative implementations may calculate holdings at different times. For example, holdings may be determined for the users at regular intervals (e.g., on a daily or weekly basis).

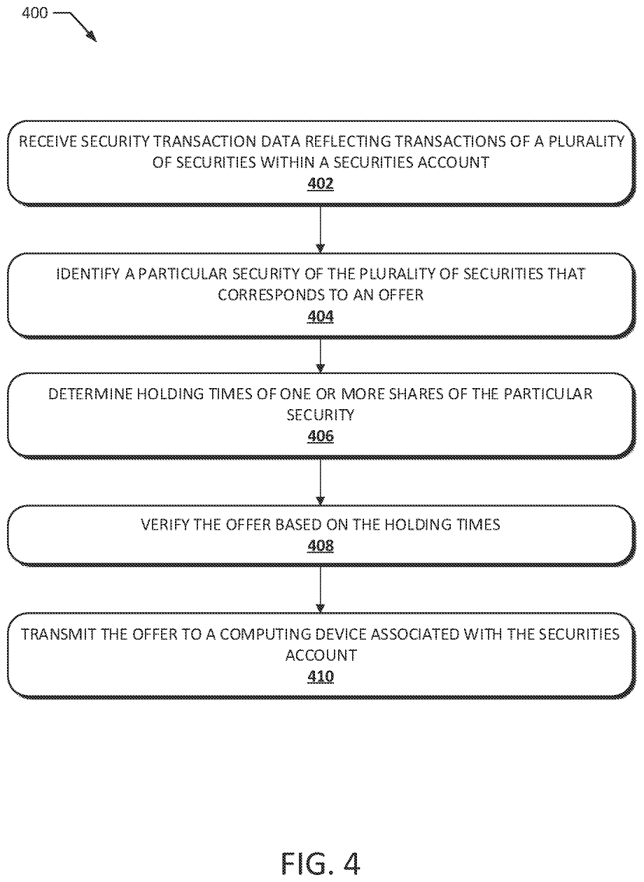

FIG. 4 illustrates a method 400 for verifying and providing securities-based offers according to an exemplary embodiment of the present disclosure. The method 400 may be implemented on a computer system, such as the systems 100, 200. For example, the method 400 may be implemented by at least one of the computing systems 102, 104, 106, 108, 204. The method 400 may also be implemented by a set of instructions stored in a computer-readable medium that, when executed by a processor, cause the computer system to perform the method 400. For example, all part of the method 400 may be implemented by a processor and a memory of the computing systems 102, 104, 106, 108, 204. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

The method 400 may begin with receiving security transaction data 120 reflecting transactions of a plurality of securities 128, 130, 140, 212, 214 within a securities account (block 402). The security transaction data 120, 304, 306 may be received by a computing system 108, 204 from another computing system 102. For example, the other computing system may implement an API such as a security platform API 202 that may be used to access security transaction data 120, 304, 306. The security transaction data 120, 304, 306 may include holdings information 206 and/or transaction data 208. The holdings information 206 may identify current holdings of the user associated with the securities account for which the security transaction data 120, 304, 306 is received. For example, the holdings information 206 may identify securities 212, 214 and corresponding quantities 213, 215 of shares for the securities 212, 214. The transaction data 208 may include dates, 124, 126, securities, 128, 130, prices 132, 134, and/or quantities 136, 138, as depicted for the security transaction data 120, 304, 306. In certain implementations the security transaction data may be received from one or more API calls. For example, separate API calls may be used to receive the holdings information 206 and the transaction data 208. In additional or alternative implementations, a single API call may be used to receive both the holdings information 206 and the transaction data 208. The security transaction data 120, 304, 306 may be received in response to a request transmitted by the computing system 108, 204. For example, the computing system 108, 204 may transmit an API request in response to a request received from a user (e.g., via a graphical user interface 114). In additional or alternative implementations, the computing system 108, 204 may be configured to update the security transaction data 120, 304, 306 of the user at regular intervals (e.g., every day, every week, every month, every quarter).

A particular security 140, 212 of the plurality of securities 128, 130, 140, 212, 214 may be identified that corresponds to an offer 122, 216, 302 (block 404). For example, the computing system 108, 204 may compare the plurality of securities 128, 130, 140, 212, 214 identified in holdings information 206 for corresponding offers 122, 216, 302. In particular, the computing system 108, 204 may store otherwise be communicatively coupled to a database that stores multiple offers associated with multiple securities. The offers may specify corresponding securities 140 and/or corresponding minimum quantities 142. The computing system 108, 204 may identify, within the database, one or more offers 122, 216, 302 that correspond to a security 140, 212 identified within the holdings information 206. Additionally or alternatively (e.g., where holdings information 206 is not received), the computing system 108, 204 may identify the one or more offers 122, 216, 302 based on transaction data 208 (e.g., that correspond to securities 128, 130 that were purchased). In certain instances, the computing system 108, 204 may further use quantity information to identify corresponding offers 122, 216, 302. For example, after initially identifying an offer 122, 216, 302 that corresponds to a security 140, 212, the computing system 108, 204 may compare a quantity 213 of shares held for the security 140, 212 to a minimum quantity 142 specified in the offer 122, 216, 302. If the current quantity 213 exceeds the minimum quantity 142, the offer 122, 216, 302 may be identified as a corresponding offer.

Holding times 150, 308, 310 may be identified for one or more shares of the particular security 140, 212 (block 406). For example, the computing system 108, 204 may identify holding times 150, 308, 310 based on security transaction data 120, 304, 306. In particular, as explained further above in connection with FIG. 3, holding periods 150, 308, 310 may be identified based on a current quantity of shares held for the particular security 140, 212 and by stepping through transactions for the particular security 140, 212 within the security transaction data 120, 304, 306 in reverse chronological order. For each particular transaction, the number of shares purchased or sold may be reversed to determine a quantity of shares held for a period of time preceding the particular transaction (e.g., for the period of time extending from the next most recent transaction until the time of the particular transaction). The computing system 108, 204 may step through the transactions in reverse chronological order until (i) reaching a transaction that occurs before the minimum holding period and/or (ii) identifying a quantity of shares that is less than the minimum quantity 142.

The offer 122, 216, 302 may be verified based on the holding times 150, 222, 308, 310 (block 408). For example, the computing system 108, 204 may compare one or more of the holding times 150, 308 to a minimum quantity 142 specified by the offer 122, 216, 302. In particular, the computing system 108, 204 may compare quantities held at each of the holding times 150, 222, 308, 310 from the current date through to the end of the minimum holding period 144. If corresponding quantities for any of the holding times are less than the minimum quantity 142, the computing system 108, 204 may determine that the user does not qualify for the offer 122, 216, 302. However, if all of the holding times through the end of the minimum holding period 144 are greater than the minimum quantity 142, the computing system 108, 204 may determine that the user does qualify for the offer and may verify the offer 122, 216, 302. In various implementations, blocks 406, 408 may be performed as separate consecutive steps and/or may be performed at least partially in parallel. For example, while processing transactions in reverse chronological order and determining the quantity of shares held at each holding time, the computing system 108, 204 may compare the quantity to the minimum quantity 142. Upon identifying a quantity less than the minimum quantity 142, the computing system 108, 204 may stop processing transactions and may determine that the user does not qualify for the offer.

If it is determined that the user qualifies for the offer 122, 216, 302, the offer 122, 216, 302 may be transmitted to a computing system 102 associated with the securities account (block 410). For example, the computing system 102 associated with the securities account may be a computing system 102 associated with the user, such as a computing system 102 implementing a graphical user interface 114 used to access or otherwise communicate with the computing system 108, 204. The offer may be presented as an alert or other visual indication within the graphical user interface 114. For example, the offer may be presented as an alert that includes a discount code the user can use to receive discounted products. As another example, the offer may be presented as a link to redeem the offer (e.g., to reveal the discount code, to access a company store web platform 118, and/or to access written/audio/video content). In still further implementations, the offer 122, 216, 302 may be presented with other means, such as by email, SMS, push notification, and the like.

In this manner, the method 400 enables robust conditioning of securities-based offers for users. In particular, the method 400 allows for verification that a user has held a specified quantity of shares of a security for the entire duration of a specified minimum holding period. Furthermore, the method 400 may reduce the processing time required to make such verifications. For example, rather than processing through an entire history of securities transaction data for a securities account, by initially using holding information, the method 400 is able to limit the analysis to transactions to only include transactions that occurred within the holding period. This reduces the overall number of transactions that have to be analyzed and reduces the overall time required, which improves the responsiveness with which securities-based offers can be identified and provided to users.

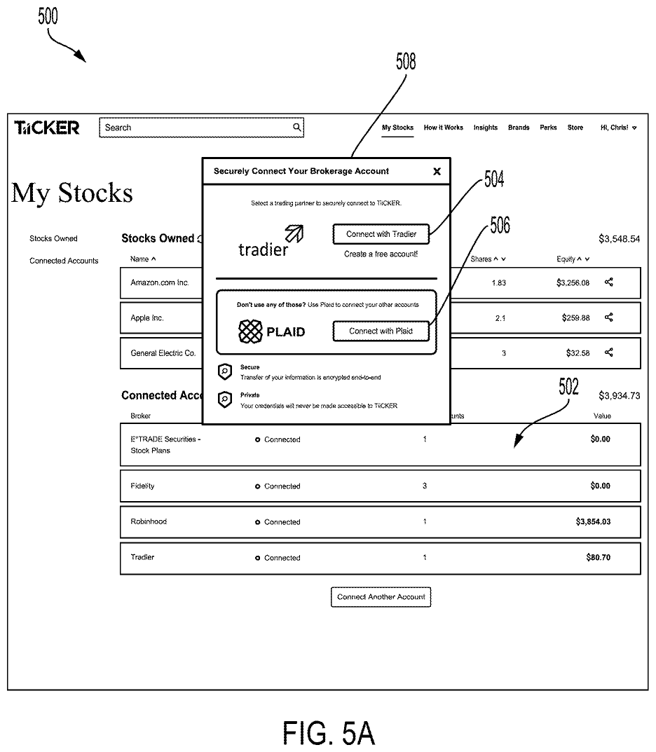

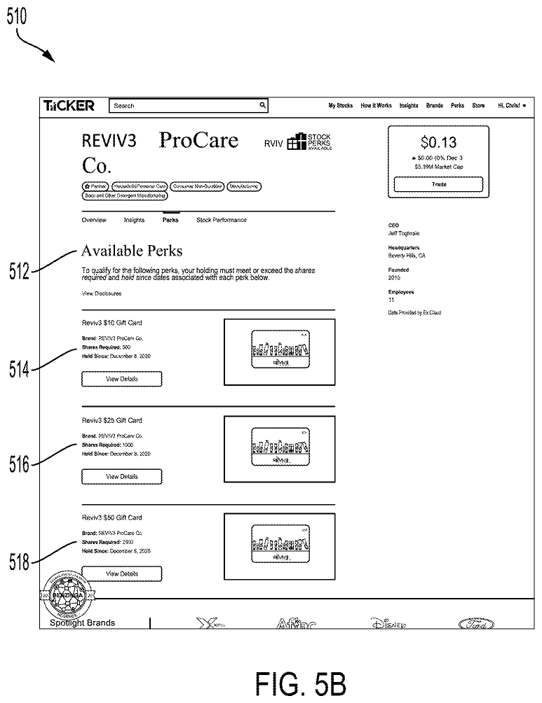

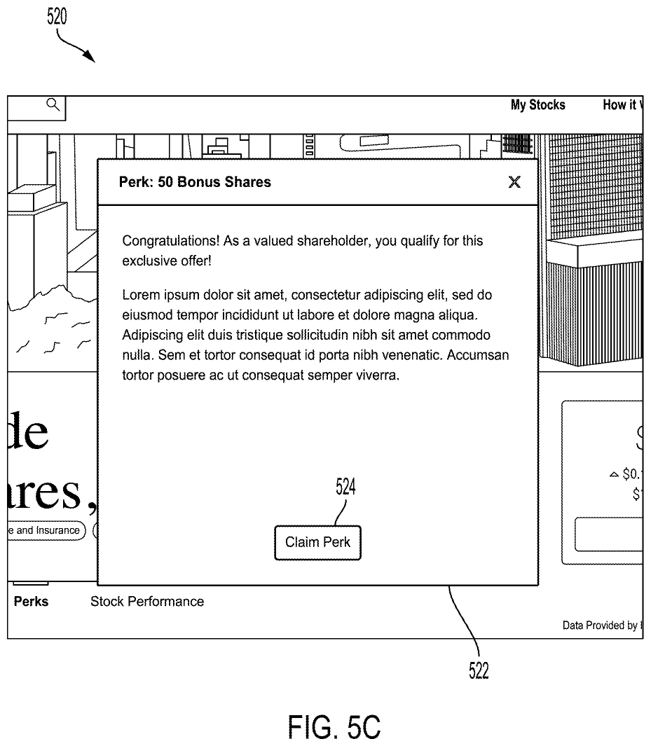

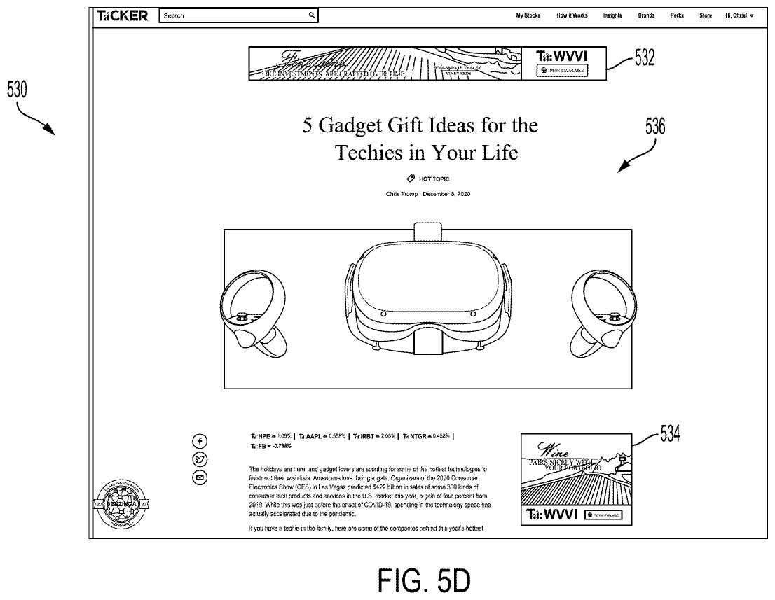

FIGS. 5A-5D illustrate graphical user interfaces 500, 510, 520, 530 according to exemplary embodiments of the present disclosure. The graphical user interface 500 depicts a user sign-up page. In particular, the user interface 500 includes a portfolio interface 502 that provides visual indications of security holdings for one or more securities accounts added by a user to a securities-based offer platform (e.g., an offer platform provided by Tiicker®). The user interface 500 also includes a securities account addition interface 508. The securities account addition interface 508 may be displayed to enable the user to add a new securities accounts to the securities-based offer platform. In particular, the securities account addition interface 508 includes two selection buttons 504, 506. Upon selecting one of the buttons 504, 506, a user may be directed through an interface flow to link the securities account to the securities-based offer platform using one or more application programming interfaces. In particular, the selection button 504 corresponds to a Tradier® API and the selection button 506 corresponds to a Plaid® API, which may represent APIs from which security transaction data is received. In certain implementations, adding a securities account may cause further processing to occur for holdings of the added securities account. For example, in response to adding a new securities accounts to the securities-based offer platform computing device may perform the method 400. In certain implementations, the securities account addition interface 508 may include additional or fewer selection buttons 504, 506 corresponding to additional or fewer APIs or account providers that may be added to the securities-based offer interfaces.

The graphical user interfaces 510, 520 may depict exemplary interfaces for presenting validated securities-based offers. In the user interface 510, an available offer section 512 is presented that contains multiple offer proposals 514, 516, 518. The offer proposals 514, 516, 518 may depict offers available for users of the securities-based offer platform. The offer proposals 514, 516, 518 may depict information regarding the available offers, such as an incentive (e.g., a gift card with a particular value, a discount), a related security, and a required quantity/holding period. In certain instances, the offer proposals 514, 516, 518 may be selected based on offers that the user qualifies for. In other instances, the offer proposals 514, 516, 518 may be selected based on current holdings for the user (e.g., that the user could qualify for if they continue holding shares for long enough). In the graphical user interface 520, a popup 522 is depicted overlaying another page of the securities-based offer platform. The pop-up 522 indicates that the user is qualified for a particular offer. Although depicted without particular contents, in certain embodiments the offer pop-up 522 may provide similar information to the offer proposals 514, 516, 518, such as identifying and incentive of the offer that the user may redeem and an underlying security that the user holds that qualified the user to receive the offer. The pop-up 522 also includes a button 524. Upon selecting the button 524, a user may be routed to a redemption flow interface to access the incentive provided by the offer. For example, the user may be presented with a discount code unlocked via the offer. Additionally or alternatively, the user may be routed to provide information so that a physical good (e.g., merchandise, a gift card) can be sent to the user. In still further implementations, the user may be routed to a company store to complete a purchase accessible via the offer.

In certain implementations, a securities-based offer platform may be configured to provide for display informational content regarding various companies with offers available via the securities-based offer platform. For example, one or more of text-based content, audio content, video content, and written content may be provided, e.g., in the form of articles, videos, and the like. For example, the graphical user interface 530 includes an article 536, which includes content individual content (e.g., of images). In addition to articles 536, the securities-based offer platform may be configured to display one or more ads 532, 534. When selected, the ads 532, 534 may redirect to other content hosted by the securities-based offer platform such that the user does not leave the user interface 530 or other user interfaces 500, 510, 520 provided by the securities-based offer platform. For example, the ads 532, 534 may redirect to an offer page for a securities-based offer available from a company depicted in the ads 532, 534, similar to the graphical user interface 520. As another example, the ads 532, 534 may redirect to another article regarding the company depicted in the ads.

It should be understood that the graphical user interfaces 500, 510, 520, 530 are merely exemplary. Certain implementations may differ from the depicted and discussed graphical user interfaces 500, 510, 520, 530, e.g., in appearance and/or in contents. Further, certain implementations may include additions interfaces beyond the graphical user interfaces 500, 510, 520, 530 discussed above.

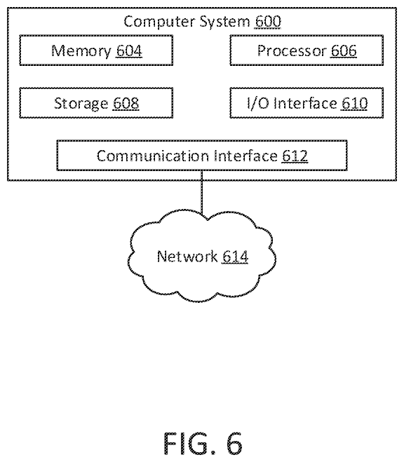

FIG. 6 illustrates an example computer system 600 that may be utilized to implement one or more of the devices and/or components discussed herein, such as the computing systems 102, 104, 106, 108, 204. In particular embodiments, one or more computer systems 600 perform one or more steps of one or more methods described or illustrated herein, such as the method 400. In particular embodiments, one or more computer systems 600 provide the functionalities described or illustrated herein. In particular embodiments, software running on one or more computer systems 600 performs one or more steps of one or more methods described or illustrated herein or provides the functionalities described or illustrated herein. Particular embodiments include one or more portions of one or more computer systems 600. Herein, a reference to a computer system may encompass a computing system, and vice versa, where appropriate. Moreover, a reference to a computer system may encompass one or more computer systems, where appropriate.

This disclosure contemplates any suitable number of computer systems 600. This disclosure contemplates the computer system 600 taking any suitable physical form. As example and not by way of limitation, the computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 606, memory 604, storage 608, an input/output (I/O) interface 610, and a communication interface 612. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 606 includes hardware for executing instructions, such as those making up a computer program. As an example and not by way of limitation, to execute instructions, the processor 606 may retrieve (or fetch) the instructions from an internal register, an internal cache, memory 604, or storage 608; decode and execute the instructions; and then write one or more results to an internal register, internal cache, memory 604, or storage 608. In particular embodiments, the processor 606 may include one or more internal caches for data, instructions, or addresses. This disclosure contemplates the processor 606 including any suitable number of any suitable internal caches, where appropriate. As an example and not by way of limitation, the processor 606 may include one or more instruction caches, one or more data caches, and one or more translation lookaside buffers (TLBs). Instructions in the instruction caches may be copies of instructions in memory 604 or storage 608, and the instruction caches may speed up retrieval of those instructions by the processor 606. Data in the data caches may be copies of data in memory 604 or storage 608 that are to be operated on by computer instructions; the results of previous instructions executed by the processor 606 that are accessible to subsequent instructions or for writing to memory 604 or storage 608; or any other suitable data. The data caches may speed up read or write operations by the processor 606. The TLBs may speed up virtual-address translation for the processor 606. In particular embodiments, processor 606 may include one or more internal registers for data, instructions, or addresses. This disclosure contemplates the processor 606 including any suitable number of any suitable internal registers, where appropriate. Where appropriate, the processor 606 may include one or more arithmetic logic units (ALUs), be a multi-core processor, or include one or more processors 606. Although this disclosure describes and illustrates a particular processor, this disclosure contemplates any suitable processor.

In particular embodiments, the memory 604 includes main memory for storing instructions for the processor 606 to execute or data for processor 606 to operate on. As an example, and not by way of limitation, computer system 600 may load instructions from storage 608 or another source (such as another computer system 600) to the memory 604. The processor 606 may then load the instructions from the memory 604 to an internal register or internal cache. To execute the instructions, the processor 606 may retrieve the instructions from the internal register or internal cache and decode them. During or after execution of the instructions, the processor 606 may write one or more results (which may be intermediate or final results) to the internal register or internal cache. The processor 606 may then write one or more of those results to the memory 604. In particular embodiments, the processor 606 executes only instructions in one or more internal registers or internal caches or in memory 604 (as opposed to storage 608 or elsewhere) and operates only on data in one or more internal registers or internal caches or in memory 604 (as opposed to storage 608 or elsewhere). One or more memory buses (which may each include an address bus and a data bus) may couple the processor 606 to the memory 604. The bus may include one or more memory buses, as described in further detail below. In particular embodiments, one or more memory management units (MMUs) reside between the processor 606 and memory 604 and facilitate accesses to the memory 604 requested by the processor 606. In particular embodiments, the memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory implementations, this disclosure contemplates any suitable memory implementation.

In particular embodiments, the storage 608 includes mass storage for data or instructions. As an example and not by way of limitation, the storage 608 may include a hard disk drive (HDD), a floppy disk drive, flash memory, an optical disc, a magneto-optical disc, magnetic tape, or a Universal Serial Bus (USB) drive or a combination of two or more of these. The storage 608 may include removable or non-removable (or fixed) media, where appropriate. The storage 608 may be internal or external to computer system 600, where appropriate. In particular embodiments, the storage 608 is non-volatile, solid-state memory. In particular embodiments, the storage 608 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. The storage 608 may include one or more storage control units facilitating communication between processor 606 and storage 608, where appropriate. Where appropriate, the storage 608 may include one or more storages 608. Although this disclosure describes and illustrates particular storage, this disclosure contemplates any suitable storage.

In particular embodiments, the I/O Interface 610 includes hardware, software, or both, providing one or more interfaces for communication between computer system 600 and one or more I/O devices. The computer system 600 may include one or more of these I/O devices, where appropriate. One or more of these I/O devices may enable communication between a person (i.e., a user) and computer system 600. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 610 may include one or more device or software drivers enabling processor 606 to drive one or more of these I/O devices. The I/O interface 610 may include one or more I/O interfaces 610, where appropriate. Although this disclosure describes and illustrates a particular I/O interface, this disclosure contemplates any suitable I/O interface or combination of I/O interfaces.

In particular embodiments, communication interface 612 includes hardware, software, or both providing one or more interfaces for communication (such as, for example, packet-based communication) between computer system 600 and one or more other computer systems 600 or one or more networks 614. As an example and not by way of limitation, communication interface 612 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 614 and any suitable communication interface 612 for the network 614. As an example and not by way of limitation, the network 614 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 600 may include any suitable communication interface 612 for any of these networks, where appropriate. Communication interface 612 may include one or more communication interfaces 612, where appropriate. Although this disclosure describes and illustrates a particular communication interface implementations, this disclosure contemplates any suitable communication interface implementation.

The computer system 602 may also include a bus. The bus may include hardware, software, or both and may communicatively couple the components of the computer system 600 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving security transaction data reflecting transactions of a plurality of securities within a securities account;
identifying a particular security of the plurality of securities that corresponds to an offer;
determining a holding period of one or more shares of the particular security;
verifying the offer based on the holding period; and
transmitting the offer to a first computing device associated with the securities account.

2. The method of claim 1, wherein the security transaction data includes information on the dates of a plurality of transactions involving the plurality of securities and quantities of the plurality of securities that purchased or sold in the plurality of transactions.

3. The method of claim 1, wherein verifying the offer comprises determining that the holding period exceeds a minimum holding period specified by the offer.

4. The method of claim 3, wherein verifying the offer comprises determining that a minimum quantity of shares have a holding period greater than the minimum holding period.

5. The method of claim 4, where determining the holding period includes analyzing transactions of the particular security from the security transaction data, wherein the transactions are analyzed in reverse chronological order to ensure that the minimum quantity of shares was held for all of the minimum holding period.

6. The method of claim 1, further comprising:
receiving, from the first computing device, a request to redeem the offer; and
redeeming the offer on behalf of the first computing device.

7. The method of claim 6, wherein redeeming the offer includes at least one of (i) providing a discount code for use at a third-party shopping platform, (ii) providing access to a company store provided by a company associated with the particular security, (iii) processing a transaction with the company associated with the particular security on behalf of the first computing device.

8. The method of claim 1, wherein the offer includes access to content regarding a company associated with the particular security, the content including one or more of written content, audio content, and video content.

9. The method of claim 1, wherein transmitting the offer includes displaying the offer in a graphical user interface on the first computing device.

10. The method of claim 9, wherein the graphical user interface includes ads that, when selected, redirect to content accessible without leaving the graphical user interface.

11. A system comprising:
a processor; and
a memory storing instructions which, when executed by the processor, cause the processor to:
receive security transaction data reflecting transactions of a plurality of securities within a securities account;
identify a particular security of the plurality of securities that corresponds to an offer;
determine a holding period of one or more shares of the particular security;
verify the offer based on the holding period; and
transmit the offer to a first computing device associated with the securities account.

12. The system of claim 11, wherein the security transaction data includes information on the dates of a plurality of transactions involving the plurality of securities and quantities of the plurality of securities that purchased or sold in the plurality of transactions.

13. The system of claim 11, wherein verifying the offer comprises determining that the holding period exceeds a minimum holding period specified by the offer.

14. The system of claim 13, wherein verifying the offer comprises determining that a minimum quantity of shares have a holding period greater than the minimum holding period.

15. The system of claim 14, where determining the holding period includes analyzing transactions of the particular security from the security transaction data, wherein the transactions are analyzed in reverse chronological order to ensure that the minimum quantity of shares was held for all of the minimum holding period.

16. The system of claim 11, wherein the instructions further cause the processor to:
receiving, from the first computing device, a request to redeem the offer; and
redeeming the offer on behalf of the first computing device.

17. The system of claim 16, wherein redeeming the offer includes at least one of (i) providing a discount code for use at a third-party shopping platform, (ii) providing access to a company store provided by a company associated with the particular security, (iii) processing a transaction with the company associated with the particular security on behalf of the first computing device.

18. The system of claim 11, wherein the offer includes access to content regarding a company associated with the particular security, the content including one or more of written content, audio content, and video content.

19. The system of claim 11, wherein transmitting the offer includes displaying the offer in a graphical user interface on the first computing device.

20. A non-transitory, computer-readable medium storing instructions which, when executed by the processor, cause the processor to:
receive security transaction data reflecting transactions of a plurality of securities within a securities account;
identify a particular security of the plurality of securities that corresponds to an offer;
determine a holding period of one or more shares of the particular security;
verify the offer based on the holding period; and
transmit the offer to a first computing device associated with the securities account.
